(19) United States
(12) Patent Application Publication
(10) Pub. No.: US 2012/0003031 A1
(43) Pub. Date: Jan. 5, 2012

(54) Connecting rod with a handle

(76) Inventor: Su-Lan LU, Taichung (TW)

(21) Appl. No.: 12/827,885

(22) Filed: Jun. 30, 2010

(51) Int. Cl. F16D 1/00

(52) U.S. Cl. 403/33

(57) ABSTRACT

A connecting rod with a handle comprises a connecting rod and a handle between which two bearing assemblies are disposed to allow the connecting rod to rotate relative to the handle smoothly. At both sides of each of bearings of the respective bearing assemblies are provided two protecting plates which can protect the connecting rod against the impact, avoiding the damage to the bearings, reducing the part damage probability and extending the service life of the connecting rod.

### BACKGROUND OF THE INVENTION

1. Field of the Invention

The present invention relates to a hand tool; and more particularly to a connecting rod with a handle.

2. Description of the Prior Art

As shown in FIG. 1, a conventional connecting rod 10 is exteriorly provided with a handle 20. In each of two opposite ends of the connecting rod 10 is disposed a bearing 11, so that when the connecting rod 10 is driven by an electric tool to rotate at a high speed, the user can hold the handle 20, while allowing the connecting rod 10 to rotate the tool, thus improving the convenience in use. However, the respective bearings 11 are located in both ends of the handle 20, so that when the connecting rod 10 falls onto the ground accidentally or is subjected to impact, the bearings 11 in both ends of the handle 20 are likely to be damaged, which might cause unsmooth rotation or even failure of the handle 20.

The present invention has arisen to mitigate and/or obviate the afore-described disadvantages.

### SUMMARY OF THE INVENTION

The primary objective of the present invention is to provide a connecting rod with a handle which can protect the bearings and extend the service life of the connecting rod.

To achieve the above objective, a connecting rod with a handle in accordance with the present invention comprises:

a connecting rod including a first connecting end and a second connecting end, the connecting rod being formed with an annular groove in an outer periphery thereof adjacent to the second connecting end;

a handle in the form of a pipe being engaged between the first connecting end and the second connecting end of the connecting rod, an inner diameter of the handle being smaller than an outer diameter of the first connecting end, the first connecting end stopping disengagement of the handle;

two bearing assemblies each including two protecting plates and a bearing, the two protecting plates abutting against both sides of the bearing, the respective bearing assemblies being disposed in both ends of the handle; and

a fastener fastened in the annular groove of the connecting rod to restrict the connecting rod in the handle.

When the connecting rod is subjected to impact accidentally, the protecting plates disposed at both sides of the respective bearings can protect the respective bearings against damage, thus reducing the part damage probability while extending the service life of the connecting rod.

### BRIEF DESCRIPTION OF THE DRAWINGS

FIG. 1 is a cross-sectional view of a conventional connecting rod with a handle;

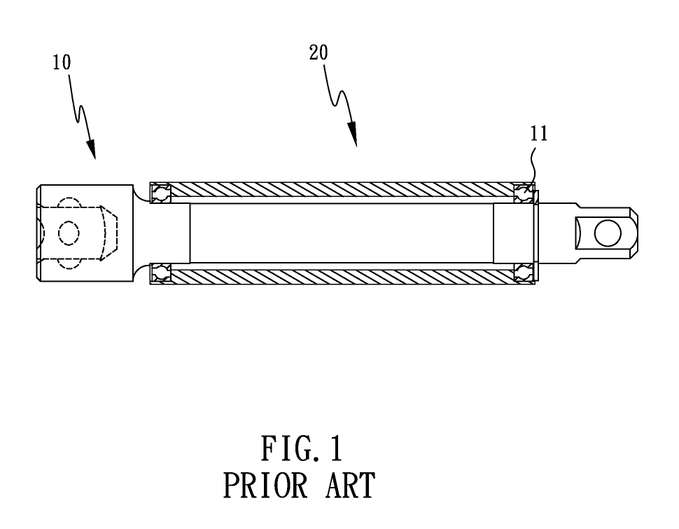

FIG. 2 is an exploded view of a connecting rod with a handle in accordance with the present invention;

FIG. 3 is a perspective view of the connecting rod with a handle in accordance with the present invention;

FIG. 4 is a cross-sectional view of the connecting rod with a handle in accordance with the present invention;

FIG. 5 is an exploded view showing that the protecting plates of the connecting rod with a handle in accordance with the present invention are coil springs;

FIG. 6 is an exploded view of another connecting rod with a handle in accordance with the present invention; and

FIG. 7 is a cross-sectional view of FIG. 6 together with a partial enlarged view.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

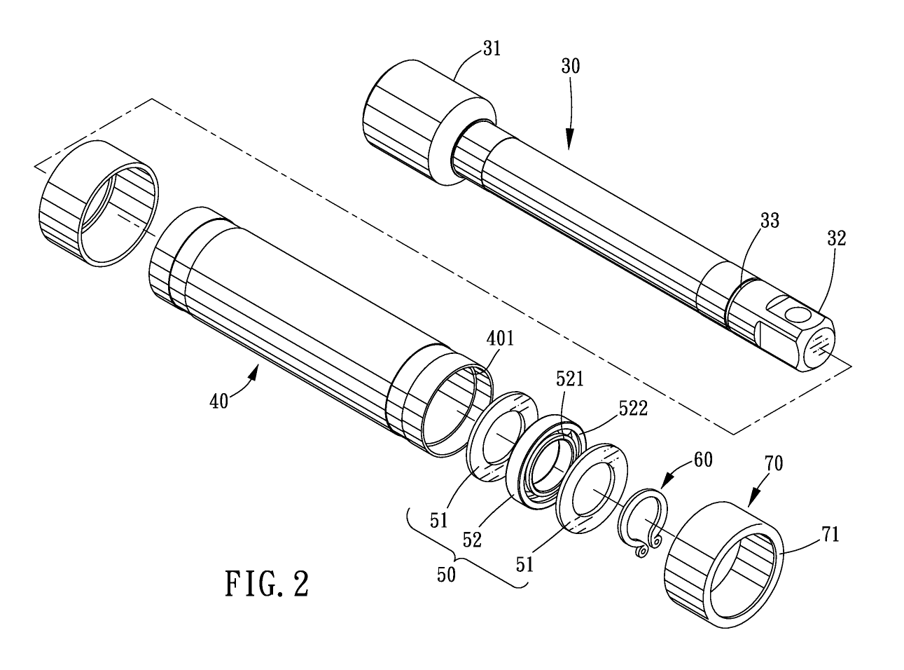

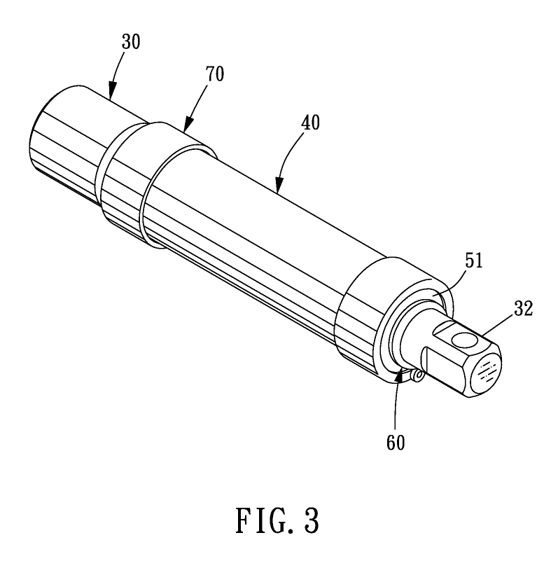

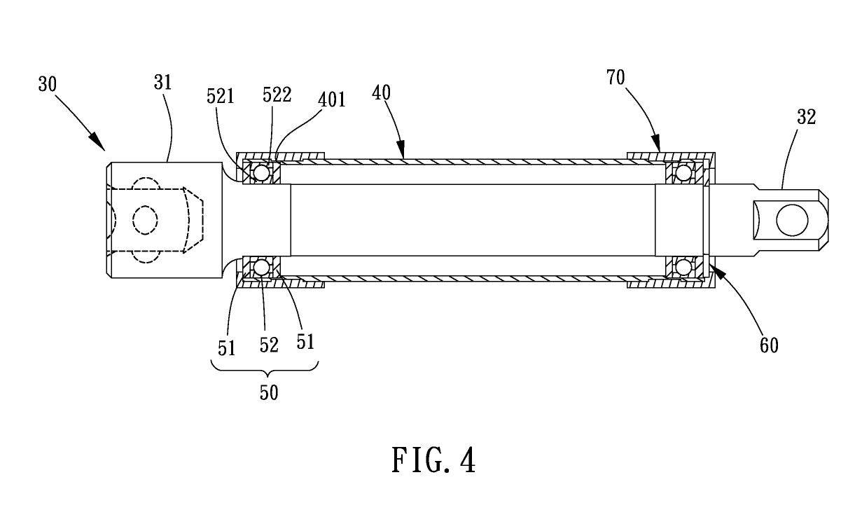

Referring to FIGS. 2-5, a connecting rod with a handle in accordance with a preferred embodiment of the present invention comprises a connecting rod 30, a handle 40, two bearing assemblies 50, a fastener 60, and two protecting covers 70.

The connecting rod 30 includes a first connecting end 31 and a second connecting end 32. The first connecting end 31 is formed with a rectangular groove, and the second connecting end 32 is configured in the form of a rectangular cylinder. The connecting rod 30 is formed in an outer periphery thereof with an annular groove 33 adjacent to the second connecting end 32.

The handle 40 is in the form of a pipe and engaged between the first connecting end 31 and the second connecting end 32 of the connecting rod 30. An inner diameter of the handle 40 is smaller than an outer diameter of the first connecting end 31. The first connecting end 31 stops the disengagement of the handle 40, and the handle 40 is formed on an inner periphery thereof with two annular flanges 401 adjacent to both ends thereof.

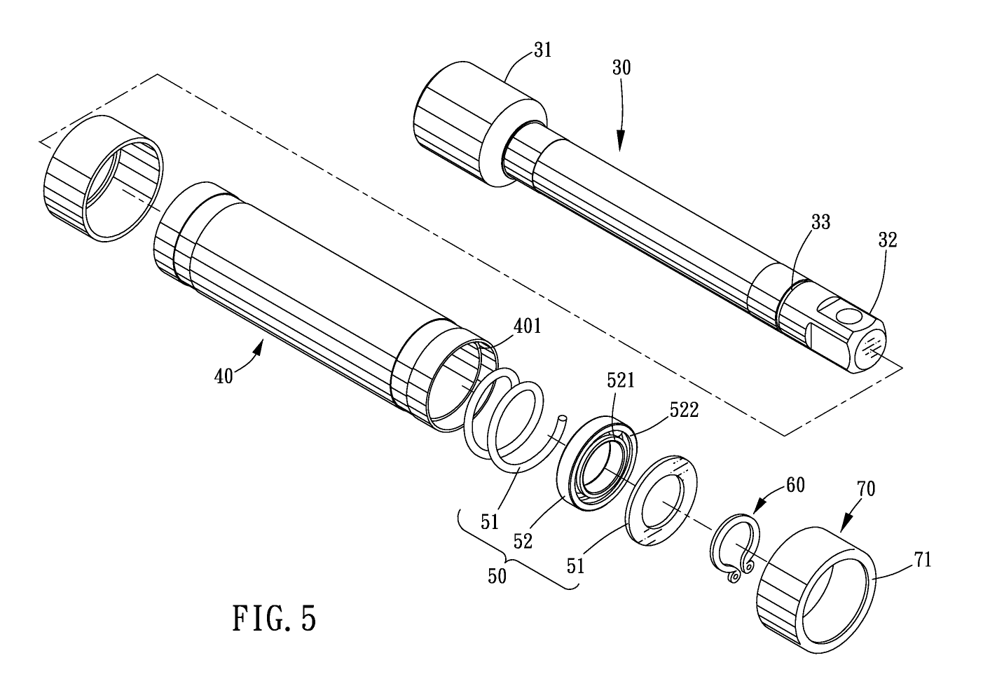

The two bearing assemblies 50 each include two protecting plates 51 and a bearing 52. The two protecting plates 51 abut against both sides of the bearing 52. The respective bearing assemblies 50 are disposed in both ends of the handle 40 while abutting against the two annular flanges 401, respectively, and the bearing 52 of each of the bearing assemblies 50 includes an inner ring 521 and an outer ring 522. The inner rings 521 can rotate relative to the respective outer rings 522. The inner rings 521 of the respective bearings 52 abut against the connecting rod 30 while the outer rings 522 of the respective bearings 52 abut against the handle 40, so that the connecting rod 30 can rotate relative to the handle 40 smoothly. The respective protecting plates 51 are elastic elements, such as coil springs, or rubber sheets. As shown in FIG. 5, the protecting plates 51 are coil springs.

The fastener 60 is fastened in the annular groove 33 of the connecting rod 30 to restrict the connecting rod 30 in the handle 40.

The two protecting covers 70 are made of buffering material, in the present embodiment, they are made of plastic. The inner peripheries of the respective protecting covers 70 are configured correspondingly to the outer peripheries of both ends of the handle 40 in such a manner that the protecting covers 70 can be engaged on both ends of the handle 40. Each of the protecting covers 70 is formed with a stopping edge 71 extending inwards correspondingly to the end edge of the handle 40 to stop the disengagement of the bearing assemblies 50.

The aforementioned is the summary of the positional and structural relationship of the respective components of the preferred embodiment in accordance with the present invention. When in use, the connecting rod 30 will be operatively connected to an electric tool, while the bearings 52 allows the handle 40 to be hold tight by the user without rotating with the connecting rod 30. If the connecting rod 30 is subjected to impact accidentally, the bearings 52 between the connecting rod 30 and the handle 40 will be protected from damage by the protecting plates 51 disposed at both sides of the respective bearings 52. Furthermore, since the respective protecting covers 70 are made of the buffering material, the respective protecting covers 70 can act as a buffering structure to reduce the replacement of the parts being damaged and extend the service life of the connecting rod 30.

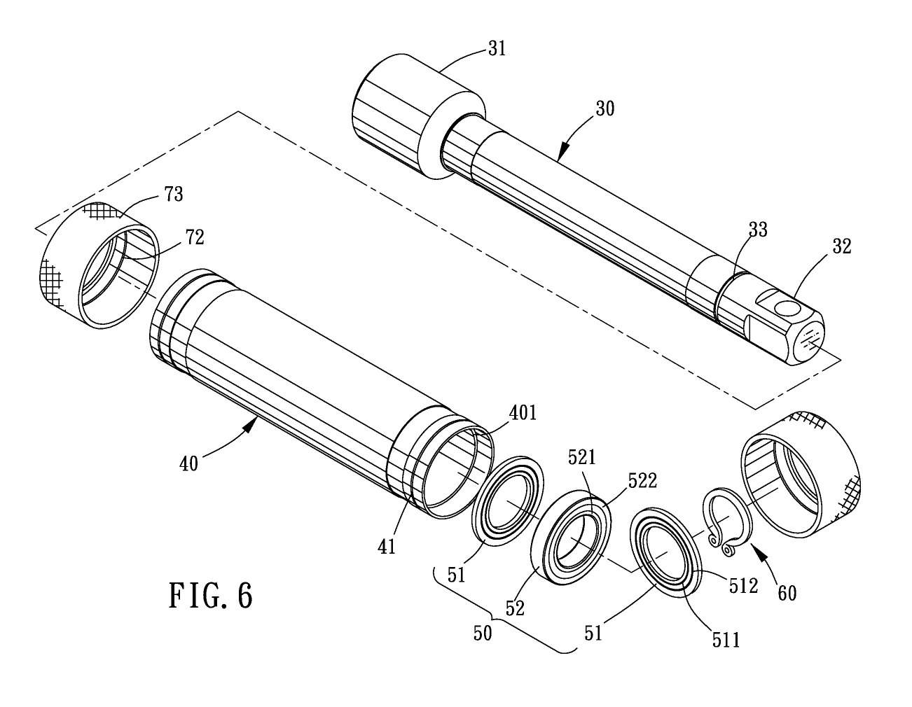

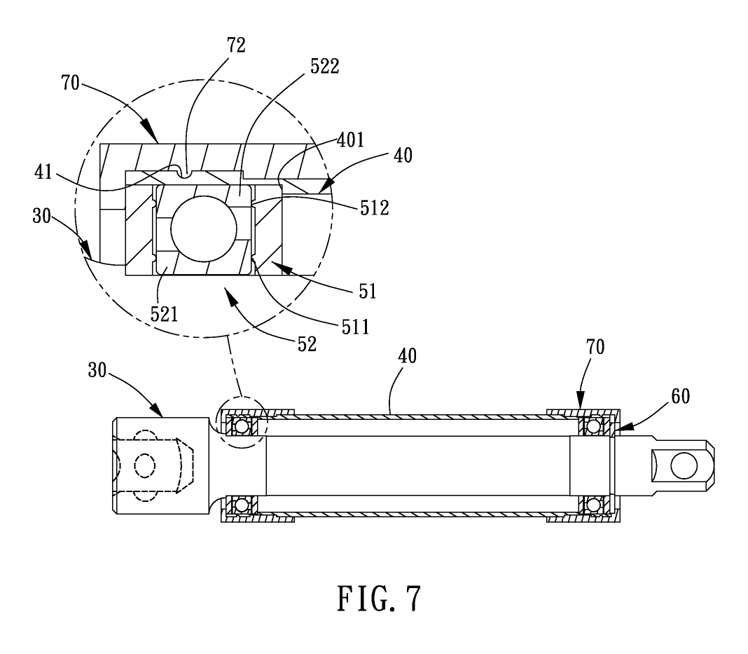

Referring to FIGS. 6-7 again, to reduce the friction between the protecting plates 51 and the respective bearings 52, each of the protecting plates 51 is provided with a first contact ring 511 and a second contact ring 512 at a side opposite the respective bearings 52 in such a manner that the first contact ring 511 is located opposite the inner ring 521 of the bearing 52 while the second contact ring 512 is located opposite the outer ring 522 of the bearing 52, by such an arrangement, the protecting plates 51 and the respective bearings 52 are brought into contact through the contact rings 511, 512 and the rings 521, 522, thus reducing the contact area between the protecting plates 51 and the respective bearings 52 while making the bearings 52 run more smoothly.

The handle 40 is formed with a positioning groove 41 in each of two ends thereof at which the two protecting covers 70 are disposed. Each of the protecting covers 70 is provided on an inner periphery thereof with a positioning flange 72 correspondingly to the respective positioning grooves 41, by such an arrangements, when the protecting covers 70 are engaged on both ends of the handle 40, the positioning flanges 72 of the respective protecting covers 70 can be engaged into the positioning grooves 41 in both ends of the handle 40 to make the respective protecting covers 70 be positioned on the handle 40 more firmly. Furthermore, each of the respective protecting covers 70 can be further provided on the outer periphery thereof with antiskid veins 73, offering an antiskid function.

While we have shown and described various embodiments in accordance with the present invention, it is clear to those skilled in the art that further embodiments may be made without departing from the scope of the present invention.

What is claimed is:

1. A connecting rod with a handle comprising:
a connecting rod including a first connecting end and a second connecting end, the connecting rod being formed with an annular groove in an outer periphery thereof adjacent to the second connecting end;
a handle in the form of a pipe being engaged between the first connecting end and the second connecting end of the connecting rod, an inner diameter of the handle being smaller than an outer diameter of the first connecting end, the first connecting end stopping disengagement of the handle;
two bearing assemblies each including two protecting plates and a bearing, the two protecting plates abutting against both sides of the bearing, the respective bearing assemblies being disposed in both ends of the handle; and
a fastener fastened in the annular groove of the connecting rod to restrict the connecting rod in the handle.

2. The connecting rod with a handle as claimed in claim 1, wherein the first connecting end of the connecting rod is formed with a rectangular groove, the second connecting end is in the form of a rectangular cylinder.

3. The connecting rod with a handle as claimed in claim 1, wherein the bearing of each of the bearing assemblies includes an inner ring and an outer ring, the inner rings are allowed to rotate relative to the respective outer rings, the inner rings of the respective bearings abut against the connecting rod while the outer rings of the respective bearings abut against the handle.

4. The connecting rod with a handle as claimed in claim 1 further comprising two protecting covers, the two protecting covers being made of buffering material, inner peripheries of the respective protecting covers being shaped correspondingly to outer peripheries of both ends of the handle, the protecting covers being engaged on both ends of the handle.

5. The connecting rod with a handle as claimed in claim 4, wherein the respective protecting covers are made of plastic, each of the protecting covers is formed with a stopping edge extending inwards correspondingly to an end edge of the handle.

6. The connecting rod with a handle as claimed in claim 1, wherein the bearing of each of the bearing assemblies includes an inner ring and an outer ring, each of the protecting plates is provided with a first contact ring and a second contact ring at a side thereof opposite the respective bearings, the first contact ring is located opposite the inner ring of the bearing while the second contact ring is located opposite the outer ring of the bearing.

7. The connecting rod with a handle as claimed in claim 4, wherein the handle is formed with a positioning groove in each of two ends thereof at which the two protecting covers are disposed, each of the protecting covers is provided on the inner periphery thereof with a positioning flange, the positioning flanges of the respective protecting covers are engaged into the positioning grooves in both ends of the handle.

8. The connecting rod with a handle as claimed in claim 4, wherein each of the protecting covers is formed on an outer periphery thereof with antiskid veins.

9. The connecting rod with a handle as claimed in claim 1, wherein the protecting plates are coil springs.

10. The connecting rod with a handle as claimed in claim 1, wherein the protecting plates are rubber sheets.
